(19) United States
(12) Patent Application Publication
(10) Pub. No.: US 2025/0052947 A1
(43) Pub. Date: Feb. 13, 2025

(54) BENT OPTICAL FIBER, METHOD FOR MANUFACTURING BENT OPTICAL FIBER, AND OPTICAL CONNECTION COMPONENT

(71) Applicant: SUMITOMO ELECTRIC INDUSTRIES, LTD., Osaka-shi, Osaka (JP)

(72) Inventors: Tsutaru KUMAGAI, Osaka-shi (JP); Tetsuya NAKANISHI, Osaka-shi (JP); Haruki KITAO, Osaka-shi (JP); Tatsuya KONISHI, Osaka-shi (JP)

(73) Assignee: SUMITOMO ELECTRIC INDUSTRIES, LTD., Osaka-shi, Osaka (JP)

(21) Appl. No.: 18/716,701

(22) PCT Filed: Nov. 9, 2022
(86) PCT No.: PCT/JP2022/041745

§ 371 Date: Jun. 5, 2024

(30) Foreign Application Priority Data
Dec. 24, 2021 (JP) 2021-210319
Mar. 14, 2022 (JP) 2022-039278

(51) Int. Cl. G02B 6/02; C03B 37/15

(52) U.S. Cl. CPC G02B 6/02395; C03B 37/15

(57) ABSTRACT

A bent optical fiber has a glass optical fiber including a first end face, a second end face, a core, a stress applying portion, and a cladding, and a resin coating. An exposed region, from which a portion of the resin coating has been removed, includes a bent portion having a curvature of 0.1 (l/mm) or more. The stress distribution in the bent portion is such that the stress on the outermost peripheral portion of the cladding is 100 MPa or less, while the stress on the core is 30 MPa or more.

### TECHNICAL FIELD

The present disclosure relates to optical a bent optical fiber, a bent optical fiber manufacturing method, and an optical connection component.

This application is based upon and claims the benefit of priority from Japanese Patent Application No. 2021-210319, filed on Dec. 24, 2021 and Japanese Patent Application No. 2022-039278, filed on Mar. 14, 2022, the entire contents of which are incorporated herein by reference.

### BACKGROUND ART

With the miniaturization of an optical module, there is a demand for a low-profile optical fiber used in the vicinity of the optical module. The low profile of optical fiber means to reduce the height of the optical fiber having one end connected vertically to an optical module, etc., from the substrate.

For the low profile of optical fiber, it is common to use a bent optical fiber, which is obtained by forming a bent portion at one end of an optical fiber. For example, Patent Document 1 and Patent Document 2 disclose an optical connection component in which a bent optical fiber is attached at an angle so that it forms a predetermined angle to the electronic substrate. However, simply bending a portion of the optical fiber to a radius of curvature of 3 mm or less, for example, in order to form a bent portion, results in excessively large distortion, i.e., bending stress to the periphery. The curvature (l/mm) is the reciprocal of the radius of curvature. In such a situation, the possibility of a bent optical fiber breaking due to excessive distortion increases, so a method is often employed to remove the distortion at a bent portion by heating the bent portion to ensure the mechanical reliability of the optical fiber. For example, Patent Document 3 discloses the manufacturing of a bent optical fiber by using arc discharge as heating means for strain release, and Patent Document 4 discloses the manufacturing of a bent optical fiber by using laser irradiation.

### CITATION LIST

### Patent Literatures

[Patent Document 1] International Publication WO2017/022085 Pamphlet
[Patent Document 2] International Publication WO2017/026072 pamphlet
[Patent Document 3] Japanese Patent Application Laid-Open No. 2008-152229
[Patent Document 4] Japanese Patent Application Laid-Open No. 2015-218090

### SUMMARY OF INVENTION

A bent optical fiber of the present disclosure is an optical component to which a polarization maintaining optical fiber (hereinafter referred to as “PMF”) is applied, and has a glass optical fiber, which is a PMF, and a resin coating. The glass optical fiber has a first end face and a second end face and includes a core, a stress applying portion, and a cladding. The core extends along a central axis from the first end face toward the second end face. The stress applying portion extends along the central axis in the same manner as the core and applies stress to the core. The cladding covers the core and the stress applying portion. The resin coating is provided on an outer peripheral surface of the glass optical fiber. An exposed region, serving as a portion of the glass optical fiber from which a portion of the resin coating has been removed and including the first end face, includes a bent portion provided at a position away from the first end face and having a curvature of 0.1 (l/mm) or more. A stress distribution in the bent portion is such that stress applied to an outermost peripheral portion, out of the cladding surrounding the core and the stress applying portion, is 100 MPa or less, while the stress applied to the core is 30 MPa or more.

A bent optical fiber manufacturing method of the present disclosure comprises: preparing; removing; and bending. In the preparing, an optical fiber to be processed, which is to become a bent optical fiber, is prepared. The optical fiber to be processed has a glass optical fiber serving as PMF, and a resin coating provided on the outer peripheral surface of the glass optical fiber. The glass optical fiber has a first end face and a second end face and includes a core, a stress applying portion, and a cladding. The core extends along a central axis from the first end face toward the second end face. The stress applying portion extends along the central axis and applies stress to the core. The cladding covers the core and the stress applying portion. The resin coating is provided on an outer peripheral surface of the glass optical fiber. In the removing, a portion of the resin coating is removed for a predetermined length from the first end face to expose a portion of the glass optical fiber including the first end face. In the bending, a portion of an exposed trigon, out of the glass optical fiber from which a portion of the resin coating has been removed, is bent by heating a section away from the first end face. In the bending, before bending, i.e., before heating the section away from the first end face, the exposed region is set in a specific state. Specifically, the exposed region of the glass optical fiber is installed in a state in which a Slow-axis, which serves as a vibration direction in which propagation velocity is minimum on a cross-section of the glass optical fiber orthogonal to the center axis, intersects a bending plane, which includes a center of the core and defines a bending direction, at an angle θslow. Then, the section to be the bent portion is heated along the bending plane so as to form a bent portion having a curvature of 0.1 (l/mm) or more while maintaining the angle θslow.

### BRIEF DESCRIPTION OF DRAWINGS

FIG. 1 is a view for explaining the bent optical fiber manufacturing method according to the present disclosure.

FIG. 2 is a view for explaining the structure and optical characteristics of the bent optical fiber according to the present disclosure.

FIG. 3 is a view for explaining the relationship between the angle θslow formed by the bending plane and the Slow-axis and the polarization extinction ratio PER, as well as the structure before and after the bending the target to be bent in the bending in the bent optical fiber manufacturing method in according to the present disclosure.

FIG. 4 is a view for explaining an example of a typical cross-sectional structure of a PMF applicable to the bent optical fiber according to the present disclosure.

FIG. 5 is a view for explaining the structural conditions (allowable range of twist) of the bent portion provided to the bent optical fiber according to the present disclosure.

FIG. 6 is a view showing the stress distribution in the side and cross-section of the exposed region in the bent optical fiber according to the present disclosure.

FIG. 7 is a view showing, as a comparative example, a device for mechanically forming a bent portion (portion that is temporarily bent) to a glass optical fiber and the stress distribution (bending stress) on the side surface of the bent portion which is mechanically formed.

FIG. 8 is a view for explaining the schematic structure of the optical connection component according to the present disclosure.

FIG. 9 is a view for explaining the structure of an example of an optical connection component according to the present disclosure.

FIG. 10 is a view for explaining the structure of another example of an optical connection component according to the present disclosure.

### DETAILED DESCRIPTION

### Problems to be Solved by Present Disclosure

As a result of examining the above-described prior art, the inventors have discovered the following issues. That is, in order to manufacture a bent optical fiber, it is necessary to form a bent portion to a portion of a prepared optical fiber, and this bent portion is generally heat-treated to the part to be the bent portion in order to give a steep bend to the optical fiber while sufficiently ensuring mechanical reliability. On the other hand, if light from a laser light source is assumed to be propagated into and out of an optical module while maintaining the polarization plane, it is necessary to apply a PMF as a bent optical fiber. However, a PMF has not been applied to a bent optical fiber at present.

In general, a PMF has a stress-applying type in which the core is given a birefringence property by stress applying portions provided along one direction on the cladding cross-section with the core as the center and having a very large thermal shrinkage rate compared to that of the cladding material. In this case, the birefringence property of the core may be significantly impaired if heat treatment is applied to the region of the PMF that is to become a bent portion. If the birefringence property of the core in the bent portion fluctuates along the longitudinal direction of the core, it becomes difficult to maintain the preset polarization extinction ratio (hereinafter referred to as “PER”), and the reheating of the PMF becomes a signal degradation factor such as the occurrence of polarization crosstalk, etc.

The present disclosure was made to solve the above-mentioned problems, and is intended to provide a bent optical fiber to which a PMF is applied, a bent optical fiber manufacturing method, and an optical connection component including the bent optical fiber.

### Advantageous Effects of Present Disclosure

According to the present disclosure, a bent optical fiber to which a PMF is applied can be obtained.

### Description of Embodiments of Present Disclosure

First, the contents of each of the embodiments of the present disclosure will be enumerated and described individually.

(1) A bent optical fiber of the present disclosure is an optical component to which a PMF is applied, and in one of its aspects, a glass optical fiber, which is a PMF, and a resin coating. The glass optical fiber has a first end face and a second end face and includes a core, a stress applying portion, and a cladding. The core extends along a central axis from the first end face toward the second end face. The stress applying portion extends along a central axis in the same manner as the core and applies stress to the core. The cladding covers the core and the stress applying portion. The resin coating is provided on the outer peripheral surface of the glass optical fiber. An exposed region, serving as a portion of the glass optical fiber from which the resin coating is removed and including the first end face, includes a bent portion provided at a position away from the first end face and having a curvature of 0.1 (l/mm) or more. A stress distribution in the bent portion is such that stress applied to an outermost peripheral portion of the cladding is 100 MPa or less and stress applied to the core is 30 MPa or more. In this specification, the outermost peripheral portion of the cladding means a portion of the cladding that includes the outer peripheral surface of the cladding and is located outside of an inner region that accounts for 90% of the cladding outer diameter centered on the core.

As described above, even when a bent portion having a curvature of 0.1 (l/mm) or more is formed in a portion of the PMF, the stress distribution of the bent portion is adjusted so that the stress on the outermost peripheral portion of the cladding surrounding the core and the stress applying portion is 100 MPa or less, while the stress on the core is 30 MPa or more, and then a bent optical fiber, in which the degradation of optical properties associated with the formation of the bent portion is effectively suppressed, can be obtained.

(2) In above-mentioned (1), the exposed region includes a first non-bent portion, a bent portion, and a second non-bent portion. The first non-bent portion includes a first end face and has a curvature of less than 0.1 (l/mm). The second non-bent portion is located on the opposite side of the first non-bent portion to the bent portion and has a curvature of less than 0.1 (l/mm). In this case, the presence of the non-bent portions at both ends of the bent portion facilitates the attachment of optical components such as a connector, etc. to both ends of the bent optical fiber.

(3) In the above-mentioned (2), the difference between the first twist angle at which the rotation reference plane and the first symmetry axis intersect and the second twist angle at which the rotation reference plane and the second symmetry axis intersect may be less than 9°, and even less than 3°. The rotation reference plane is a plane including the center of the core located inside the exposed region. The first symmetry axis defines the arrangement pattern of the core and the stress applying portion as a line-symmetry figure on the first cross-section perpendicular to the central axis at the boundary between the first non-bent region and the bent portion. The second symmetry axis is a symmetry axis corresponding to the first symmetry axis, and defines the arrangement pattern of the core and stress applying portion as a line-symmetry figure on the second cross-section perpendicular to the central axis at the boundary between the second non-bent region and the bent portion. In this way, the twisted state in the bent optical fiber to which the PMF is applied is kept within an acceptable range, effectively reducing the degradation of the PER.

(4) In any one of the above-mentioned (1) to (3), the bent optical fiber may have a PER of less than-15 dB, or even less than-20 dB. In this case, the polarization maintaining characteristics sufficient for practical use are maintained even when compared with the PMF before bending.

(5) A bent optical fiber manufacturing method of the present disclosure comprises: preparing; removing; bending; and cooling. In the preparing, an optical fiber that is to be processed is prepared to be made into a bent optical fiber. The optical fiber to be processed has a glass optical fiber serving as a PMF and a resin coating provided on the outer peripheral surface of the glass optical fiber. The glass optical fiber has a first end face and a second end face and includes a core, a stress applying portion, and a cladding. The core extends along the central axis from the first end face toward the second end face. The stress applying portion extends along the central axis and stresses the core. The cladding covers the core and the stress applying portion. The resin coating is provided on the outer peripheral surface of the glass optical fiber. In the removing, a portion of the resin coating is removed for a predetermined length from the first end face to expose a portion of the glass optical fiber including the first end face. In the bending, a portion of the exposed region is bent by heating a section away from the first end face, out of the exposed region of the glass optical fiber from which a portion of the resin coating has been removed. In the cooling, the section having been heated is cooled at a decreasing rate of 100° C./s or more until the surface temperature of the section decreases from the maximum temperature at the time of heating to 1000° C. or less. When a PMF is applied to a bent optical fiber, the bent portion is formed by heating a portion of the PMF (a portion of the exposed region where a portion of the resin coating is removed). However, the formation of the bent portion by heating may significantly impair the birefringence property of the core at the bent portion. In contrast, according to the manufacturing method of the present disclosure, even if a portion of the PMF to be applied to the bent optical fiber is reheated, the degradation of the polarization maintaining property at the bent portion is effectively suppressed by undergoing the cooling.

(6) A bent optical fiber manufacturing method of the present disclosure comprises: preparing; removing; and bending. In the preparing, an optical fiber that is to be processed is prepared to be made into a bent optical fiber. The optical fiber to be processed has a glass optical fiber serving as a PMF and a resin coating provided on the outer peripheral surface of the glass optical fiber. The glass optical fiber has a first end face and a second end face and includes a core, a stress applying portion, and a cladding. The core extends along the central axis from the first end face toward the second end face. The stress applying portion extends along the central axis and stresses the core. The cladding covers the core and the stress applying portion. The resin coating is provided on the outer peripheral surface of the glass optical fiber. In the removing, a portion of the resin coating is removed for a predetermined length from the first end face to expose a portion of the glass optical fiber including the first end face. In the bending, a portion of the exposed region, out of the glass optical fiber from which a portion of the resin coating has been removed, is bent by heating a section away from the first end face. In the bending, before bending, i.e., before heating the section away from the first end face, the exposed region is set in a specific state. Specifically, the exposed region of the glass optical fiber is installed in a state where the Slow-axis, which serves as a vibration direction in which propagation velocity is minimum on the cross-section of the glass optical fiber orthogonal to the center axis, intersects a bending plane, which is a plane including a center of the core and defines a bending direction, at an angle θslow. Then, the section to be a bent portion is heated along the bending plane to form the bent portion having a curvature of 0.1 (l/mm) or more while maintaining the angle θslow. This configuration makes it possible to keep the PER at a state of less than-20 dB.

(7) In the above-mentioned (6), the bent optical fiber manufacturing method may further include the cooling. In the cooling, the section having been heated is cooled at a decreasing rate of 100° C./s or more until the surface temperature of the section decreases from the maximum temperature at the time of heating to 1000° C. or less. When a PMF is applied to a bent optical fiber, the bent portion is formed by heating a portion of the exposed region of the PMF from which a portion of the resin coating has been removed. However, the formation of the bent portion by heating may significantly impair the birefringence property of the core in the bent portion. In contrast, according to the manufacturing method of the present disclosure, even if a portion of the PMF to be applied to the bent optical fiber is reheated, the degradation of the polarization maintaining property of the bent portion is effectively suppressed by undergoing the cooling.

(8) The bent optical fiber of the present disclosure is a bent optical fiber is manufactured by the bent optical fiber manufacturing method of the above-mentioned (6) or (7), wherein the bent portion is sandwiched between a first non-bent portion with a curvature of less than 0.1 (l/mm) including the first end face and a second non-bent portion with a curvature of less than 0.1 (l/mm). In this bent portion, the angle formed with the Slow-axis with respect to the bending plane is preferably 0° or more and 45° or less. This configuration makes it possible to suppress the PER to less than-20 dB.

(9) An optical connection component of the present disclosure may comprise a bent optical fiber of any one of the above-mentioned (1) to (4) and (8), a connecting member, and a reinforcing member. The connecting member is attached to the tip portion of the bent optical fiber including the first end face, i.e., the region on the first end face side than the bent portion. The reinforcing member reinforces at least the bent portion of the bent optical fiber. As described above, the PMF applied to the bent optical fiber has non-bent portions at both ends of its bent portion, which facilitates the attachment of optical components such as a connector, etc. to both ends of the bent optical fiber. In addition, the durability of the optical connection component as a whole is improved by the provision of the reinforcing member that physically reinforces the bent portion.

(10) In the above-mentioned (9), the optical connection component may comprise a plurality of bent optical fibers each having the same structure as the bent optical fiber having the structure as described above. Each of the plurality of bent optical fibers has the same structure as the bent optical fiber in the above-mentioned (9). The connecting member preferably includes a glass plate having a plurality of through holes provided corresponding to each of the plurality of bent optical fibers, or a fixing member having a plurality of V-grooves provided corresponding to each of the plurality of bent optical fibers. For example, making a fiber ribbon integrally comprising a plurality of bent optical fibers enables more efficient connection work at the time of fiber laying, and also makes it possible to realize an increase in communication capacity.

(11) In the above-mentioned (10), the plurality of bent optical fibers constituting a part of the optical connection component may include at least two types of bent optical fibers with different cross-sectional structures. For example, the glass optical fibers of the plurality of bent optical fibers may include a single-mode optical fiber (hereinafter referred to as “SMF”) as well as a PMF. In this case, any combination of bent optical fibers can be selected according to the application.

### Details of Embodiments of Present Disclosure

Hereinafter, a bent optical fiber, a bent optical fiber manufacturing method, and an optical connection component according to the present disclosure will be described in detail with reference to the accompany drawings. The present invention is not limited to these examples, but is defined by the scope of the claims, and is intended to include meanings equivalent to the scope of the claims and all modifications within the scope. In addition, the same elements will be denoted by the same reference signs in the description of the drawings, without redundant description.

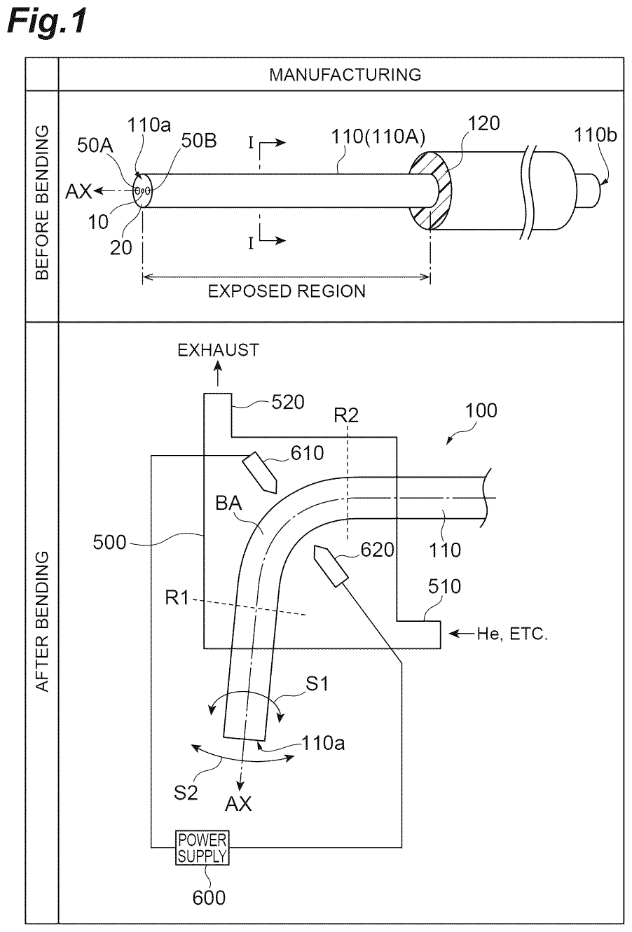

FIG. 1 is a view for explaining the manufacturing method of the bent optical fiber 100 according to the present disclosure (hereinafter referred to as “manufacturing” in FIG. 1). The upper part of FIG. 1 (hereinafter referred to as “before bending” in FIG. 1) shows the PMF applied to the bent optical fiber. The lower part of FIG. 1 (hereinafter referred to as “after bending” in FIG. 1) shows the schematic configuration of the bend forming apparatus in which the bending and the cooling are performed.

As shown in the upper part of FIG. 1, the optical fiber to be processed, which is to become the bent optical fiber 100, has the glass optical fiber 110, which is a PMF, having the first end face 110a and the second end face 110b, and the resin coating 120 provided on the outer peripheral surface of the glass optical fiber 110, wherein the bent portion BA is formed in the region which includes the first end face 110a and from which the resin coating 120 has been removed, i.e., in the exposed region defined by the section from the first end face 110a to the remaining portion of the resin coating 120. The glass optical fiber 110 serving as the PMF has the core 10 extending along the fiber axis AX corresponding to the central axis of the glass optical fiber 110, the stress applying portions 50A and 50B extending along the fiber axis AX as well as the core 10, and the cladding 20 surrounding the core 10 and the stress applying portions 50A and 50B.

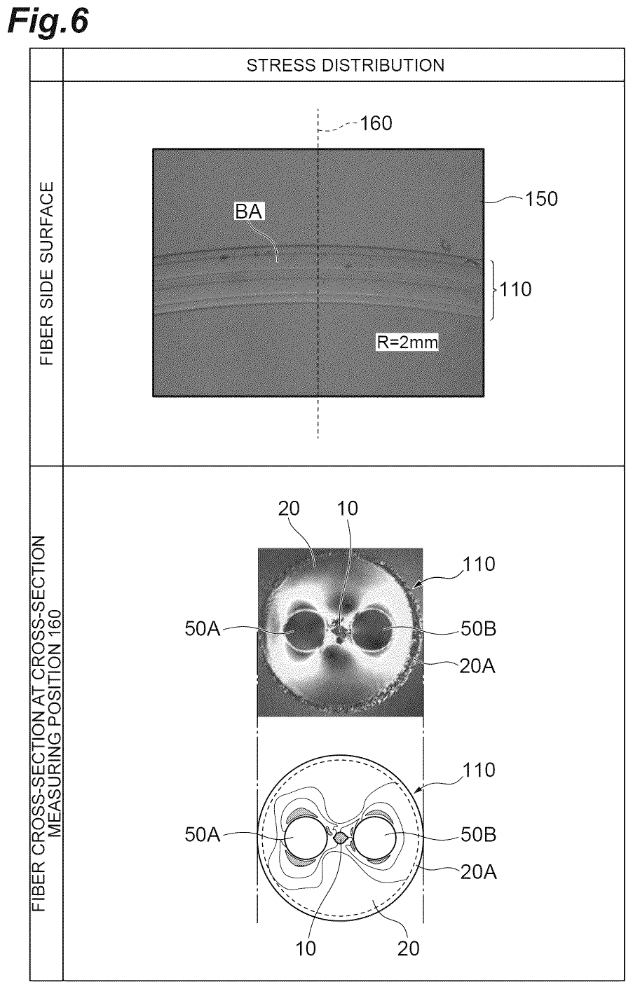

The PMF, for example, has a structure in which circular stress applying portions 50A and 50B are arranged on both sides of core 10, as shown in the upper part of FIG. 1. In the manufacturing therefor, holes for stress applying portions are first formed on both sides of the part that will be the core of the preform for SMF, and the inner surfaces of the holes are ground and polished. Then, the glass rods doped with B₂O₃ to increase the coefficient of linear expansion are inserted into the holes for stress applying portions, and the preform for SMF and the B₂O₃-doped glass rods are heated to form a single piece to obtain the preform for PMF. The obtained preform for PMF is cooled immediately after fiber formation in the drawing, and then tensile strain is induced in the stress applying portions, which have a large linear expansion coefficient compared to the pure silica glass in the portion to be the cladding. This results in the application of stress to the core along one direction, for example, tensile stress due to the contraction of the stress applying portion, as shown in the lower part of FIG. 6.

In the case of manufacturing the bent optical fiber 100 using the PMF manufactured as described above, for example, the bent portion BA is formed at a position away from the first end face 110a, out of the exposed region of the glass optical fiber 110 by the bend forming apparatus shown in the lower part of FIG. 1.

The example of the bend forming apparatus shown in the lower part of FIG. 1 comprises: the discharge electrodes 610 and 620 for heating a portion of the exposed region located at the tip portion of the glass optical fiber 110 while holding the optical fiber to be processed that includes the glass optical fiber 110 serving as the PMF; and the power supply 600 for causing arc discharge between these discharge electrodes 610 and 620. The bend forming apparatus also comprises the cooling chamber 500 for rapid cooling of the region with high-temperature that is bent by arc discharge. The cooling chamber 500 has: an inlet 510 for, as a cooling medium, inert gas such as He having high heat conduction efficiency, N₂ causing an endothermic reaction with oxygen in a high temperature environment, etc.; and an outlet 520.

The cooling of the high temperature region in the glass optical fiber 110 after bending can also be realized by directly blowing the inert gas instead of the above cooling chamber 500. The formation of the bent portion BA of the glass optical fiber 110 is not limited to arc discharge, but can also be realized by a burner, a CO₂ laser, a heater, etc., for example. The CO₂ laser has advantageous characteristics for precise control of curvature distribution because the irradiation intensity, irradiation range, and irradiation time can be easily adjusted. At around 10 μm, which is the typical wavelength of the CO₂ laser, glass is opaque, so the irradiation energy of the CO₂ laser is considered to be absorbed at the surface layer of the optical fiber and transferred to the inside of the optical fiber by re-radiation and thermal conduction. If the power of the CO₂ laser is too high, the temperature of the surface layer of the optical fiber rises steeply to the evaporation temperature of the glass, and as a result, the surface shape of the optical fiber cannot be maintained. Therefore, the irradiation power of the CO₂ laser is appropriately adjusted so that the surface layer glass of the optical fiber does not evaporate and the temperature rises above the working point at the fiber cross-section in the heated portion for a predetermined time to remove the strain.

An example of the method for manufacturing the bent optical fiber 100 using the bend forming apparatus as described above includes: preparing; removing; bending; and cooling. However, the cooling may not be performed. The following description relates to an example where the cooling is implemented in the cooling chamber 500 for the bend forming apparatus shown in the lower part of FIG. 1. In the preparing, an optical fiber that is to be processed is prepared to be made the bent optical fiber 100. The optical fiber to be processed includes a glass optical fiber 110 serving as the PMF as shown in the upper part of FIG. 1. In the removing, a portion of the resin coating 120 of a predetermined length from the first end face 110a is removed to secure an exposed region where the bent portion BA should be formed. In other words, the exposed region is a portion of the glass optical fiber 110 including the first end face 110a. In the bending, a portion of the exposed region, out of the glass optical fiber 110, is bent by heating a section away from the first end face 110a by arc discharge or other means using the bend forming apparatus shown in the lower part of FIG. 1. In the cooling, the high-temperature section after bending, which has been heated, is cooled at a decreasing rate of 100° C./s or more until the surface temperature of the section decreases from the maximum temperature at the time of heating to 1000° C. or less. When the PMF is applied to the bent optical fiber 100, the reheating of a portion of the exposed region where a portion of the resin coating has been removed may cause degradation of the polarization-maintaining characteristics of the PMF. However, the cooling immediately following the bending effectively suppresses the degradation of polarization-maintaining properties at the bent portion BA.

In the bent optical fiber 100 obtained through the above processes, the bent portion BA having a curvature of 0.1 (l/mm) or more is formed in the exposed region while being sandwiched between the boundary R1 located on the first end face 110a side and the boundary R2 located on the second end face 110b side. Another example of the manufacturing method of the present disclosure may comprise: preparing, removing; and bending. The bent optical fiber 100 in which the bent portion BA is formed by arc discharge, etc. may rotate the tip portion of the glass optical fiber 110, specifically the section sandwiched between the first end face 110a and the boundary R1, along the twisting direction indicated by the arrow S1, or may swing in the twisting direction indicated by the arrow S2. In this case, the polarization maintaining characteristics of the obtained bent optical fiber 100 may deteriorate, so it is advisable to set a tolerance in advance, as described below. Such an example of the manufacturing method of the present disclosure may also include the cooling described above, which effectively suppresses the degradation of the polarization-maintaining property at the bent portion BA.

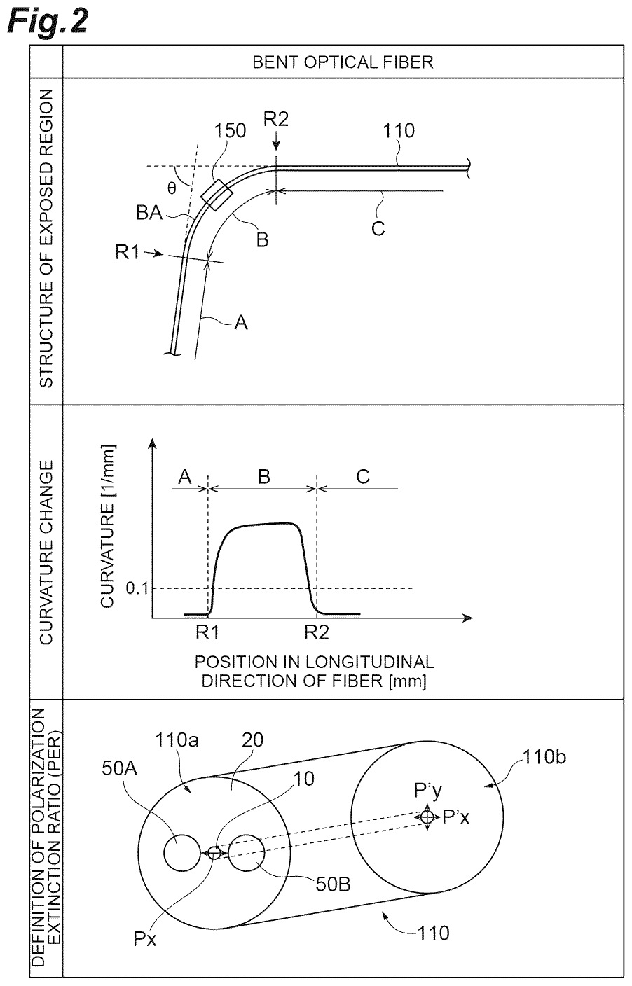

FIG. 2 is a view for explaining the structure and optical characteristics of the bent optical fiber 100 according to the present disclosure (hereinafter referred to as “bent fiber” in FIG. 2). The upper part of FIG. 2 (hereinafter referred to as “structure of exposed region”) shows a portion of the glass optical fiber 110 of the bent optical fiber 100 including the bent portion BA. The middle part of FIG. 2 (hereinafter referred to as “curvature change”) shows the curvature change of the bent portion BA and its surroundings. The lower part of FIG. 2 (hereinafter referred to as “definition of polarization extinction ratio (PER)”) shows the polarization states of the input light at the first end face 110a and the second end face 110b of the glass optical fiber 110 (before bending).

As shown in the upper part of FIG. 2 and the middle part of FIG. 2, the bent portion BA and its vicinity in the exposed region of the glass optical fiber 110 are constituted by the region A having a curvature of less than 0.1 (l/mm), the region B having a curvature of 0.1 (l/mm) or more, and the region C having a curvature of less than 0.1 (l/mm). Here, the region A is a first non-bent portion continuous to the bent portion BA, the region B is a heated region corresponding to the bent portion BA, and the region C is a second non-bent portion continuous to the bent portion BA. The bent portion BA, which is distinguished from the region A corresponding to the first non-bent portion and the region C corresponding to the second non-bent portion by the boundaries R1 and R2, maintains its bending shape without fixing both ends of the region B, as shown in the upper part of FIG. 2. Therefore, no bending stress remains in the region B. At least, the bending stress on the outermost peripheral portion of the cladding 20 is reduced to 100 MPa or less. On the other hand, in the region A and the region C, which correspond to the first non-bent portion and the second non-bent portion, the bent state cannot be maintained unless both ends of the region are fixed. In other words, in the region A and the region BC, bending stress always remains while the bent state is maintained.

In the upper part of FIG. 2, as shown above, the boundary R1 shows a boundary between the region A and the region B, and the boundary R2 shows a boundary between the region B and the region C, respectively, and these regions A, B, and C are continuous regions of the bent optical fiber 100. In this specification, “bending angle θ” is defined by the angle formed by two straight lines extending along each of the region A and the region C, which are located on both sides of the region B serving as the bent portion BA, as shown in the upper part of FIG. 2.

The PMF model shown in the lower part of FIG. 2 is a schematic model of the glass optical fiber 110 serving as a PMF. The PMF model corresponding to the glass optical fiber 110 has a first end face 110A and a second end face 110B. The glass optical fiber 110 is constituted by the core 10, the stress applying portions 50A and 50B, and a cladding 20. Generally, in the PMF, when an X-polarization mode Px is inputted to the first end face 110a from a laser source, a Y-polarization mode P′y is observed along with the X-polarization mode P′x at the second end face 110b. The polarization-maintaining characteristics of the PMF are evaluated by the PER defined by the light intensity ratio (P′y/P′x) of this X-polarization mode P′x and Y-polarization mode P′y. Specifically, the PER is defined by the following formula:

PER (Polarization Extinction Ratio)=10·log (P′y/P′x).

In the cross-section of the glass optical fiber 110, the direction of oscillation in which light travels slowly, i.e., the direction of high refractive index, is called “Slow-axis”, and the direction of oscillation in which light travels quickly, i.e., the direction of low refractive index, is called “Fast-axis”.

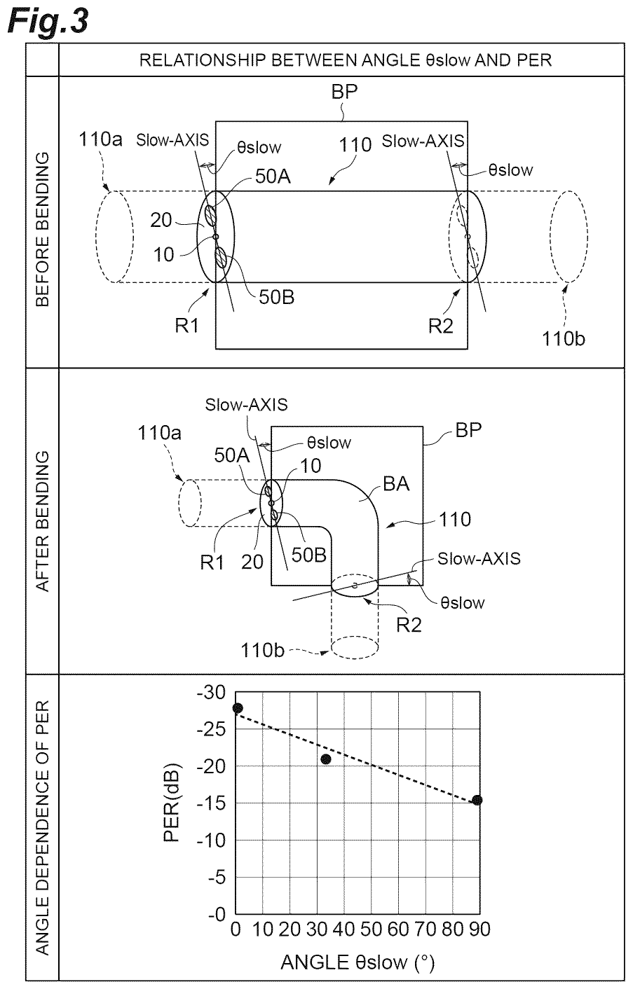

FIG. 3 is a view for explaining the relationship between the absolute value θslow, on the acute side of the angle between the bending plane BP and the Slow-axis, and PER, as well as the structure before and after bending the target to be bent in the bending in the bent optical fiber manufacturing method according to the present disclosure (hereinafter referred to as “relationship between angle θslow and PER” in FIG. 3). The upper part of FIG. 3 (hereinafter referred to as “before bending” in FIG. 3) shows the installation state of the glass optical fiber 110 before bending. The middle part of FIG. 3 (hereinafter referred to as “after bending” in FIG. 3) shows the change in position after bending between the bent portion BA and the bending plane obtained by heating. The lower part of FIG. 3 (hereinafter referred to as “angle dependence of PER” in FIG. 3) shows a graph in which the polarization extinction ratio: PER (dB) is plotted against the acute angle θslow (°) between the Slow-axis and the bending plane BP.

As shown in the upper part of FIG. 3 (before bending), in the bending, the exposed region of the glass optical fiber 110, including the section between the boundary R1 away from the first end face 110a and the boundary R2, is a plane containing the center of the core 10 and is installed in the state that the bending plane BP defining the bending direction and the Slow-axis intersect at an angle θslow.

The section sandwiched between the boundary R1 and the boundary R2 is then heated to form the bent portion BA with the curvature of 0.1 (l/mm) or more. At this time, the bending plane BP and the Slow-axis are kept intersected at the angle θslow, as shown in the middle part of FIG. 3. In order to keep the bending plane BP and the Slow axis intersected, it is preferable to use a twist-free optical fiber, for example. After eliminating the twist at the tip portion of the optical fiber prior to heating for bending, the optical fiber in which the twist is eliminated may be fixed, for example, by configuring it as a part of a connector or a fiber array. In the exposed region of the glass optical fiber 110, the region A from the first end face 110a to the boundary R1 and the region C located on the side of the second end face 110b from the boundary R2 have the curvature of less than 0.1 (l/mm).

The graph shown in the lower part of FIG. 3 plots the PER (dB) against the angle θslow) (° in the bent optical fiber shown in the middle part of FIG. 3, where the bending plane BP and the Slow-axis intersect at the angle θslow from the boundary R1 to the boundary R2. The dashed line shown in the graph is an approximate straight line indicating the angle dependence of the polarization extinction ratio, and when the horizontal axis indicating the angle θslow) (° formed by the bending plane BP and the Slow-axis is set to the x-axis and the vertical axis indicating the polarization extinction ratio (PER) is set to the y-axis, this approximate formula is y=−0.1361x+26.955.

As can be seen from the graph shown in the lower part of FIG. 3, the bent optical fiber 100 according to the present disclosure can suppress the PER to less than −15 dB after bending, and the PER can be suppressed to less than −20 dB by controlling the angle θslow formed by the bending plane BP and the Slow-axis to be 0° or more and 45° or less. Furthermore, by controlling the angle θslow between the bending plane BP and the Slow-axis to be 10° or less, the PER can be suppressed to less than −25 dB. As a result, sufficient polarization maintaining characteristics can be maintained for practical use compared to the PMF before bending.

As the glass optical fiber 110, it is suitable to apply a PMF having a mode field diameter (hereinafter referred to as “MFD”) of 6 μm or more and 9.6 μm or less at a wavelength of 1.31 μm and a cable cutoff wavelength of 1260 nm or less, or a PMF having a MFD of 6 μm or more and 10.8 μm or less at a wavelength of 1.55 μm and a cable cutoff wavelength of 1480 nm or less. The bent portion BA provided on the exposed region of the glass optical fiber 110 should have a bending radius of 3 mm or less, i.e., a curvature of ⅓ (l/mm) or more, for the low-profile of optical component. The polarization extinction ratio should be less than-20 dB, preferably less than-25 dB, based on the above considerations.

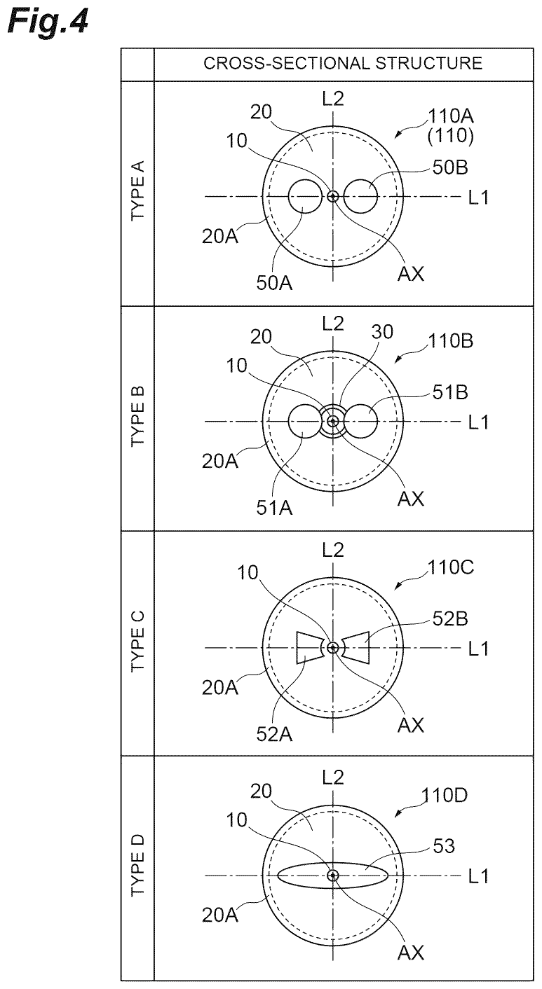

FIG. 4 is a view for explaining an example of a typical cross-sectional structure of a PMF applicable to the bent optical fiber according to the present disclosure (hereinafter referred to as “cross-sectional structure” in FIG. 4). The top part of FIG. 4 (hereinafter referred to as “type A” in FIG. 4) shows the cross-sectional structure of a so-called “PANDA fiber” as a typical PMF shown in FIG. 1, etc. The second part of FIG. 4 (hereinafter referred to as “type B” in FIG. 4) shows the cross-sectional structure of a so-called “Bend-Insensitive-type PANDA fiber” with bending resistance. The third part of FIG. 4 (hereinafter referred to as “type C” in FIG. 4) shows the cross-sectional structure of a so-called “bow-tie fiber” with stress applying portions in which a special cross-sectional shape is employed. The bottom part of FIG. 4 (hereinafter referred to as “type D” in FIG. 4) also shows the cross-sectional structure of a so-called “elliptical cladding fiber” with a stress applying portion employing a special cross-sectional shape.

As shown in the top part of FIG. 4, the glass optical fiber 110A of “PANDA fiber” shown in FIG. 1, etc. as the PMF of type A is constituted by the core 10 extending along the fiber axis AX, the stress applying portions 50A and 50B having a circular cross-sectional shape and arranged to sandwich the core 10, and the cladding 20 covering the core 10 and the stress applying portions 50A and 50B. The cladding 20 includes an outermost peripheral portion 20A which includes an outer peripheral surface and surrounds the core 10 and the stress applying portions 50A and 50B. The “L1” and “L2” shown in the top part of FIG. 4 are symmetry axes that define the arrangement pattern of the core 10 and the stress applying portions 50A, 50B on the cross-section of this glass optical fiber 110A as a line-symmetry figure, and serve as an orientation axis indicating the orientation of the cross-section of the glass optical fiber 110A. In effect, the symmetry axis L1 corresponds to the Slow-axis and the symmetry axis L2 corresponds to the Fast-axis. The same is true for any of the following examples of type B through type D.

As shown in the second part of FIG. 4, the glass optical fiber 110B of “Bend-Insensitive-type PANDA fiber” as the PMF of type B is constituted by the core 10 extending along the fiber axis AX, the trench layer 30 surrounding the core 10 and having a refractive index lower than that of the core 10, the stress applying portions 51A and 51B having a circular cross-sectional shape arranged to sandwich the core 10 and the trench layer 30, and a cladding 20 covering the core 10, the trench layer 30 and the stress applying portions 51A and 51B. The cladding 20 an outermost peripheral portion 20A which includes an outer peripheral surface and surrounds the core 10, the trench layer 30, and the stress applying portions 51A and 51B. The second part of FIG. 4 also shows the symmetry axis L1 and the symmetry axis L2, which define the arrangement pattern of the core 10, the trench layer 30, and the stress applying portions 51A, 51B on the cross-section of the glass optical fiber 110B as a line-symmetry figure, as the orientation axis indicating the orientation of the cross-section of the glass optical fiber 110B.

As shown in the third part of FIG. 4, the glass optical fiber 110C of “bow-tie fiber” as the PMF of type C is constituted by the core 10 extending along the fiber axis AX, the stress applying portions 52A and 52B having a trapezoidal cross-sectional shape and arranged to sandwich the core 10, and a cladding 20 covering the core 10 and the stress applying portions 52A and 52B. The cladding 20 includes an outermost peripheral portion 20A which includes an outer peripheral surface and surrounds the core 10 and the stress applying portions 52A and 52B. The third part of FIG. 4 also shows the symmetry axes L1 and L2, which define the arrangement pattern of the core 10 and the stress applying portions 52A and 52B on the cross-section of the glass optical fiber 110C as a line-symmetry figure, as the orientation axis indicating the orientation of the cross-section of the glass optical fiber 110C.

Furthermore, as shown in the bottom part of FIG. 4, the glass optical fiber 110D of “elliptical cladding fiber” as the PMF of type D is constituted by the core 10 extending along the fiber axis AX, the stress applying portion 53 surrounding the core 10 and having an elliptical cross-sectional shape, and a cladding 20 covering these cores 10 and the stress applying portion 53. The cladding 20 includes the outermost peripheral portion 20A which includes an outer peripheral surface and surrounds the core 10 and the stress applying portion 53. The bottom part of FIG. 4 also shows the symmetry axes L1 and L2, which define the arrangement pattern of the core 10 and the stress applying portions 53 as line-symmetry figures on the cross-section of the glass optical fiber 110D, as the orientation axis indicating the orientation of the cross-section of the glass optical fiber 110D.

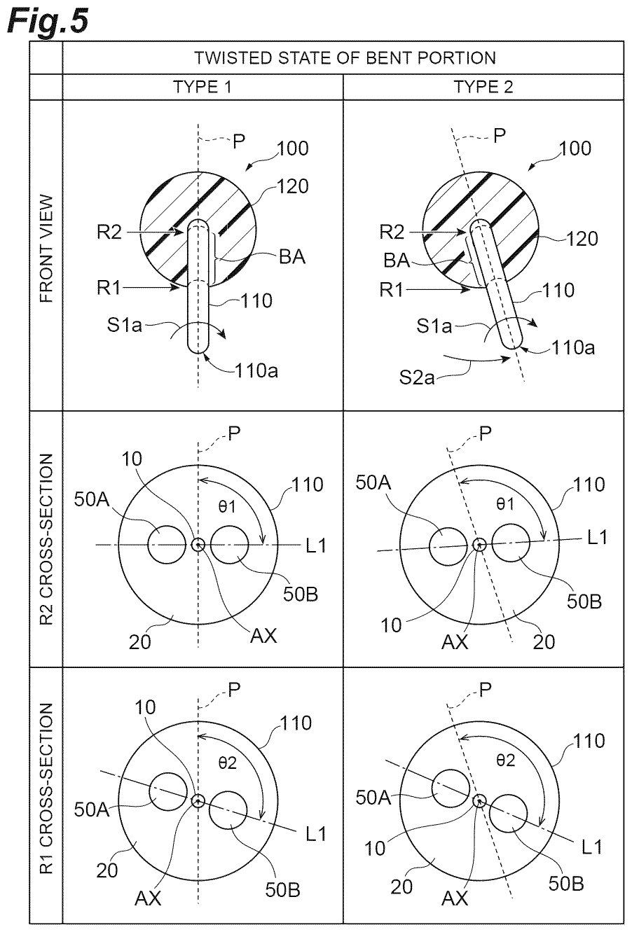

FIG. 5 is a view for explaining the structural conditions (allowable range of twist) of the bent portion in the bent optical fiber according to the present disclosure (hereinafter referred to as “twisted state of bent portion” in FIG. 5). The upper part of FIG. 5 (hereinafter referred to as “front view” in FIG. 5) shows a front view of the bent optical fiber 100 when the bent optical fiber 100 shown in the lower part of FIG. 1 is viewed from the left side of the drawing toward the right side of the drawing. The middle part of FIG. 5 (hereinafter referred to as “R2 cross-section” in FIG. 5) shows the cross section of the glass optical fiber 110 at the boundary R2. The lower part of FIG. 5 (hereinafter referred to as “R1 cross-section” in FIG. 5) shows the cross-section of the glass optical fiber 110 at the boundary R1.

In this specification, the twisted state of the bent portion BA formed in the exposed region of the bent optical fiber 100, especially the glass optical fiber 110, is defined by the absolute value of the angular difference between the direction of the orientation axis at the boundary R1 and that at the boundary R2, with respect to the rotation reference plane P. As shown in the upper part of FIG. 5, a state in which the bent portion BA located between the boundaries R1 and R2 is twisted along the arrow Sla (denoted as “Type 1” in FIG. 5) and a state in which the bent portion BA is twisted along the arrow Sla and swung along the arrow S2a (denoted as “Type 2” in FIG. 5) are assumed. The rotation reference plane P is defined as a plane containing the center of the core 10 located inside the exposed region. The orientation axes are defined on the cross-section of the bent portion BA at the boundary R1 and on the cross-section of the bent portion BA at the boundary R2, respectively, and are, for example, in the example shown in the top part of FIG. 4, the symmetry axes L1 and L2 defining the arrangement pattern of the core 10 and stress applying portions 50A and 50B as a line-symmetry figure. Although the two symmetry axes L1 and L2 can be defined in all examples shown in FIG. 4, one symmetry axis of the two symmetry axes L1 and L2, corresponding at the boundary R1 and R2, may be used to identify the twisted state. In the case of the angle between the rotation reference plane P and the orientation axis, the corresponding angles at the boundaries R1 and R2 are also compared. In the following description, the symmetry axis L1 defined on the cross-section of the glass optical fiber 110 at each of the boundary R1 and boundary R2 is used as the orientation axis.

First, as shown in the middle of FIG. 5, on the cross-section of the boundary R2 of the glass optical fiber 110 corresponding to one end face of the bent portion BA, for the twisted state of each type 1 and type 2, the angle between the orientation axis serving as the symmetry axis L1 and the rotation reference plane P is measured as the twist angle θ1 at the boundary R2. On the other hand, as shown in the lower part of FIG. 5, on the cross-section of the boundary R1 of the glass optical fiber 110 corresponding to the other end face of the bent portion BA, for the twisted state of each of type 1 and type 2, the angle between the orientation axis serving as the symmetry axis L1 and the rotation reference plane P is also measured as the twist angle θ2 at the boundary R1. Since both twist angles θ1 and θ2 are angles relative to the rotation reference plane P, the difference between twist angles θ1 and θ2 simply means the angle difference indicating the twisted state of the bent portion BA located between the boundary R1 and R2.

The twisted state of the bent portion BA is identified by the difference between the twist angle θ2 at the boundary R1 and the twist angle θ1 at the boundary R2 (=|θ1−θ2|). In the case of the bent optical fiber 100 according to the present disclosure, the difference between the orientation of the symmetry axis L1 corresponding to the orientation axis at the boundary R1 and the orientation of the symmetry axis L1 corresponding to the orientation axis at the boundary R2 may be less than 9°, and even less than 3°. By keeping the twisted state in the bent optical fiber 100 of the present disclosure to which the PMF is applied within such an acceptable range, the degradation of PER can be effectively reduced. In order to keep the twisted state of the bent portion BA formed in the exposed region of the glass optical fiber 110 within the above-mentioned allowable range, the bending should be performed while the tip portion of the glass optical fiber 110 including the first end face 110a is fixed, as described in Patent Document 4, for example.

FIG. 6 is a view showing the stress distribution in the side and cross-section of the exposed region of the bent optical fiber 100 according to the present disclosure (hereinafter referred to as “stress distribution” in FIG. 6). The bent optical fiber 100 according to the present disclosure is an optical component in which the bend forming apparatus as shown in the lower part of FIG. 1 has performed the formation of the bent portion BA and the cooling of the bent portion BA to the exposed region of a glass optical fiber 110 as shown in the upper part of FIG. 1. The upper part of FIG. 6 (hereinafter referred to as “fiber side surface” in FIG. 6) shows the measurement screen 150 as an image of the side surface of the bent portion BA as observed by a phase contrast microscope. The lower part of FIG. 6 (hereinafter referred to as “fiber cross-section at cross-section position 160” in FIG. 6) shows the observed image by the phase contrast microscopy of the cross-section of the bent portion BA and a schematic diagram thereof.

As described above, the bent portion BA of the glass optical fiber 110 included in the bent optical fiber 100 of the present disclosure is formed by performing the bending by heating in the bend forming apparatus shown in the lower part of FIG. 1, and therefore the bending stress in the bent portion BA is released. Specifically, as shown in the upper part of FIG. 6, the observed image of the side surface of the bent portion BA provided in the exposed region of the glass optical fiber 110 is, in effect, the observed image of the outermost peripheral portion 20A of the cladding 20, and this observed image shows no overall shade change. This means that the bending stress is released at the side surface of the bent portion BA. On the other hand, the bent portion BA of the glass optical fiber 110 is subjected to the bending followed by the cooling in the bend forming apparatus shown in the lower part of FIG. 1. This reproduces a state in which stress is applied along one direction to the core of the bent portion BA. Specifically, the lower part of FIG. 6 shows the fiber cross-section at the cross-section position 160 shown in the measurement screen 150 in the upper part of FIG. 6, and as shown in this lower part of FIG. 6, it can be confirmed that the observed image of the bent portion BA at the cross-section position 160 shows significant shading changes around the core 10 and the stress applying portions 50A and 50B. In this schematic diagram of the shading change, the hatched area means the area where the compressive stress is particularly concentrated. The core 10 is located within the region where the maximum compressive stress is applied.

The phase contrast microscope of the two-dimensional birefringence evaluation system can be used for stress measurement. In other words, the stress can be calculated by converting the distribution of birefringence/phase difference measured quantitatively with the phase contrast microscope from a theoretical equation to a stress value. Specifically, birefringence (phase difference) is generated by applying stress even to a sample such as a transparent material with no birefringence property. The relationship between the generated stress σ and the phase difference δ can be expressed by the following formula, and the above equation allows the stress or stress distribution to be quantified:

σ=δ/(β−d).

where β is the photoelastic modulus and d is the thickness of the sample.

In the case of the bent optical fiber 100 of the present disclosure, the bending stress applied to the outermost peripheral portion 20A at the bent portion BA having the curvature of 0.1 (l/mm) or more is adjusted to 100 MPa or less. On the other hand, the stress applied to the core 10 at the bent portion BA is adjusted to 30 MPa or more. Thus, according to the manufacturing method of the present disclosure, even when the bent portion BA is formed by reheating the glass optical fiber 110 included in the PMF, the desired stress distribution can be reproduced in the bent portion BA. Therefore, in the obtained bent optical fiber 100 of the present disclosure, the degradation of optical properties associated with the formation of the bent portion BA can be effectively suppressed. The lower the absolute value of the stress applied to the outermost peripheral portion 20A, the lower the stress, and the closer to 0 MPa the better. The stress applied to the core 10 may be equal to the stress applied to the outermost peripheral portion 20A, and may be 100 MPa or less. The stress applied to the core 10 may be different from the stress applied to the outermost peripheral portion 20A and may be 100 MPa or less, but may be 100 MPa or more, 200 MPa or more, or 3000 MPa or less. However, the stress value of 3000 MPa is the limit value at which the optical fiber can maintain its shape, and if this stress value is exceeded, the optical fiber itself will break.

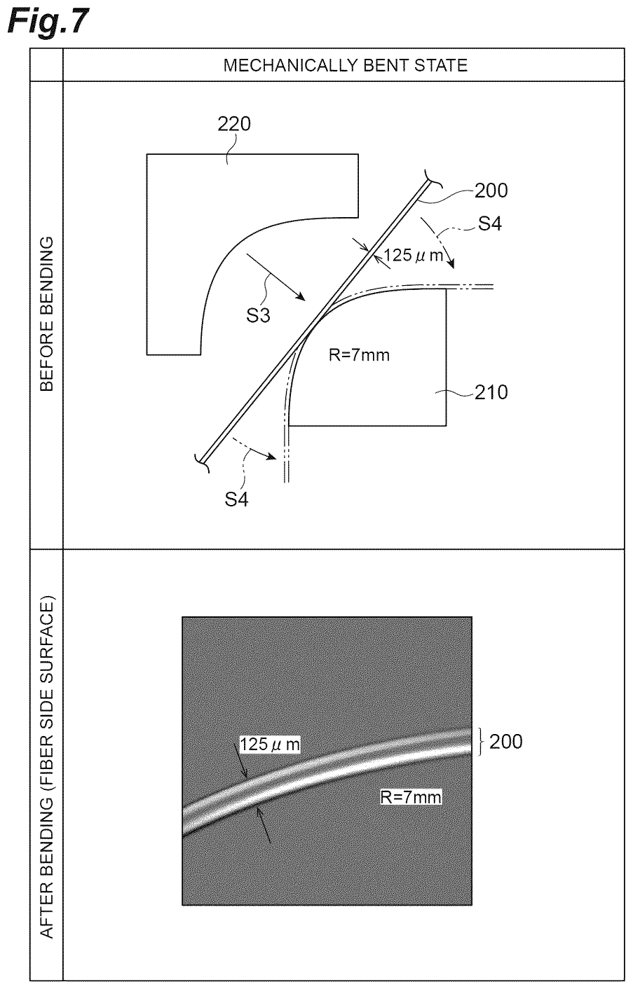

FIG. 7 is a view showing, as a comparative example, a device for mechanically forming a bent portion to a glass optical fiber 200 and the stress distribution on the side surface of the bent portion which is mechanically formed (hereinafter referred to as “mechanically bent state” in FIG. 7). The bent portion of the comparative example shown in FIG. 7 is a portion which is temporarily bent. The upper part of FIG. 7 (hereinafter referred to as “before bending” in FIG. 7) shows, as a comparative example, a device for forming a bent portion to the glass optical fiber 200 from which the resin coating has been removed. The lower part of FIG. 7 (hereinafter referred to as “after bending (fiber side surface)” in FIG. 7) shows an image of the side of the mechanically formed bent portion as observed by the phase contrast microscope.

The mechanically bent state is achieved, as shown in the upper part of FIG. 7, by sandwiching the glass optical fiber 200 between the fiber holding portion 210 having an aspect with a radius of curvature R set to 7 mm and the lid portion 220 having a curved surface matching the curved surface of the fiber holding portion 210. Here, the glass optical fiber 200 is the PMF having a cladding diameter of 125 μm, and the resin coating in the region where the bent portion is formed is removed. With the glass optical fiber 200 in contact with the curved surface of the fiber holding section 210, the glass optical fiber 200 is bent along the deformation direction indicated by arrow S4 by pressing the curved surface of the lid section 220 against the curved surface of the fiber holding section 210 along the movement direction indicated by arrow S3.

At this time, the side surface of the glass optical fiber 200 is subjected to bending stress, as shown in the lower part of FIG. 7. In the observed image shown in the lower part of FIG. 7, the lighter color indicates the greater bending stress, and the bending stress is most concentrated in the white area in the observed image. Compared to the case where a part of the exposed glass optical fiber is bent by heating, it is clear that the mechanical strength of the bent optical fiber itself is reduced because the bending stress is concentrated in the bent part of the glass optical fiber that has been mechanically bent.

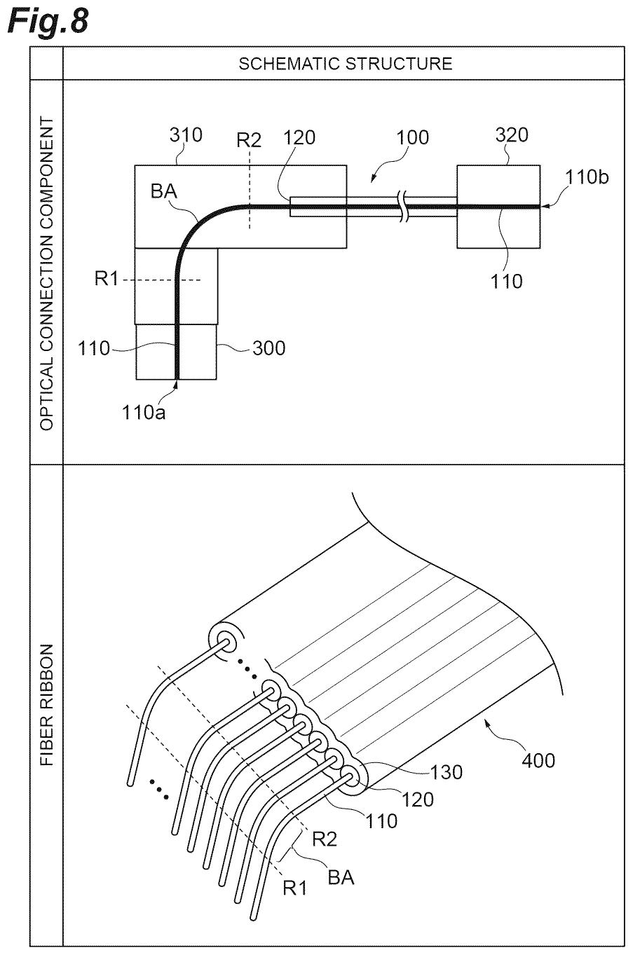

FIG. 8 is a view for explaining the schematic structure of the optical connection component according to the present disclosure (hereinafter referred to as “schematic structure” in FIG. 8). The upper part of FIG. 8 (hereinafter referred to as “optical connection component” in FIG. 8) shows the components that make up the optical connection component according to the present disclosure. The lower part of FIG. 8 (hereinafter referred to as “fiber ribbon” in FIG. 8) shows a fiber ribbon constituted by a plurality of bent optical fibers.

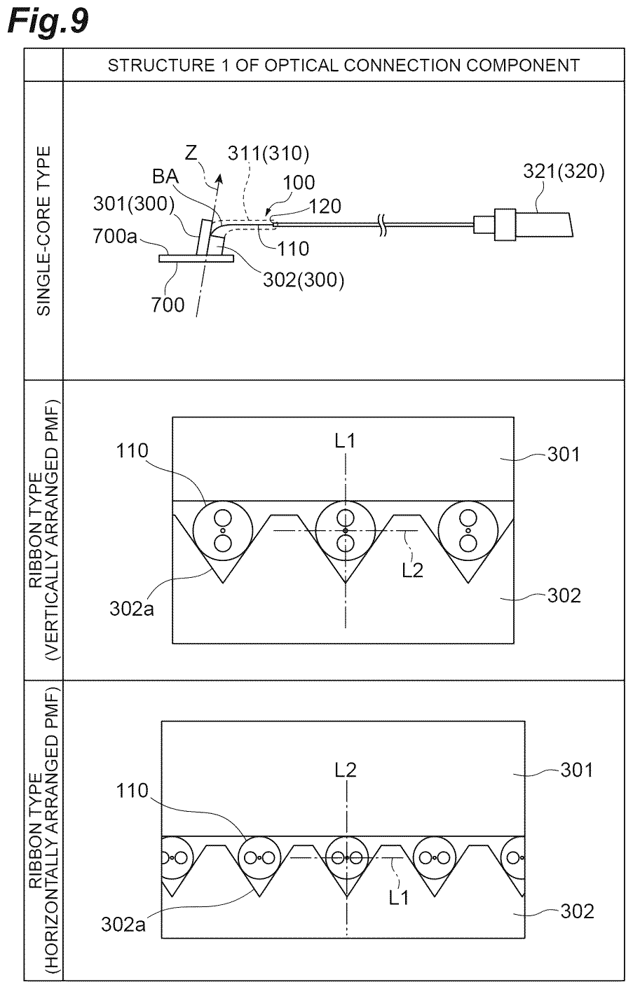

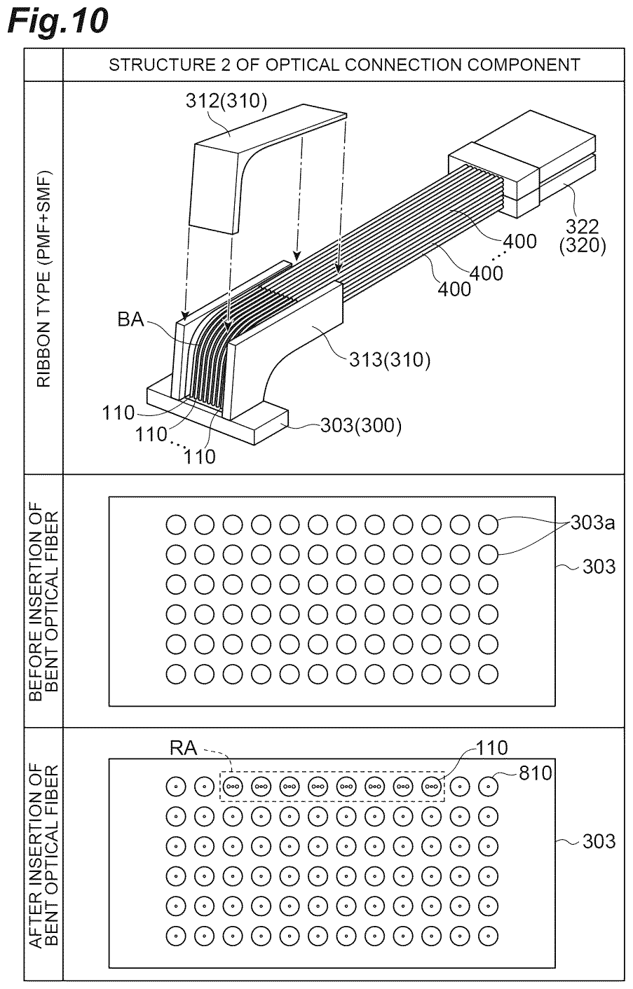

As shown in the upper part of FIG. 8, the optical connection component according to the present disclosure has: the bent optical fiber 100 of the present disclosure manufactured by the bend forming apparatus capable of performing the cooling as shown in the lower part of FIG. 1; the first connecting member 300; the reinforcing member 310; and a second connecting member 320. As described above, the bent optical fiber 100 has: the glass optical fiber 110 having the first end face 110a, the second end face 110b, and the bent portion BA located between the first end face 110a and the second end face 110b; and a resin coating 120 provided on the outer peripheral surface of the glass optical fiber 110. A part of the resin coating 120 is removed from the tip portion of the glass optical fiber 110 including the first end face 110a, and the bent portion BA is formed between the boundary R1 and the boundary R2 in this exposed region. The first connecting member 300 is attached to a portion of the glass optical fiber 110 that includes the first end face 110a. The first connecting member 300 includes, for example, a glass plate with a through hole into which the glass optical fiber 110 is inserted, or a fixing member having a V-groove. When, as shown in the lower part of FIG. 8, the fiber ribbon 400 constituted by the plurality of bent optical fibers 100, each including the glass optical fiber 110 and the resin coating 120, instead of one bent optical fiber 100, is applied to the optical connection component, it is necessary for the glass plate to have a plurality of through holes as shown in the middle part of FIG. 10. It is also necessary for the fixing member to have a plurality of V-grooves, as shown in the middle and lower parts of FIG. 9.

Furthermore, the reinforcing material 310 is a material or component that physically reinforces the bent portion BA in the exposed region of the glass optical fiber 110. The reinforcing material and reinforcing component are shown in the upper parts of FIG. 9 and FIG. 10, respectively, as an example. Materials applicable to the reinforcing material 310 include, for example, polycarbonate, poly phenylene sulfide (PPS) resin, liquid crystal polymers, etc. Alternatively, the reinforcing member 310 may be a reinforcing component that grips the bent portion BA of the glass optical fiber 110 with a plurality of members. The tip portion of the glass optical fiber 110 including the second end face 110B also has a portion of the resin coating 120 removed, and the second connecting member 320 is attached to this exposed tip portion. However, when attaching the second connecting member 320 to the glass optical fiber 110, it is preferable to have a function to precisely position the glass optical fiber 110, and an example of this second connecting member 320 includes a FC connector, a MT connector, etc. Thus, the bent optical fiber 100 to which the PMF is applied has the non-bent portions at both ends of the bent portion BA, which facilitates the attachment of the first connecting member 300 and the second connecting member 320, such as connectors, to the ends of the bent optical fiber 100. In addition, the durability of the optical connection component as a whole can be improved by providing the reinforcing member 310 that physically reinforces the bent portion BA.

The lower part of FIG. 8 shows the fiber ribbon 400 that can be applied to the optical connection component in place of the single bent optical fiber 100. This fiber ribbon 400 is constituted by the plurality of bent optical fibers 100, and the plurality of bent optical fibers 100 are integrated by the common resin 130. Each bent optical fiber 100 comprises: the glass optical fiber 110 serving as the PMF; and the resin coating 120, and then the bent portion BA is provided between the boundaries R1 and R2. As described above, the fiber ribbon formation in which the plurality of bent optical fibers 100 are integrally composed of a common resin 130 enables efficient connection work and increased communication capacity at the time of fiber laying.

FIG. 9 is a view for explaining the structure of an example of an optical connection component according to the present disclosure (hereinafter referred to as “structure 1 of optical connection component” in FIG. 9). The upper part of FIG. 9 (hereinafter referred to as “single-core type” in FIG. 9) shows a specific installation of the optical connection component in which a single bent optical fiber 100 is applied to connect a light emitting device on the electronic substrate 700 to the other optical component via a connector. The middle part of FIG. 9 (hereinafter referred to as “ribbon type (vertically arranged PMF)” in FIG. 9) shows the end faces of the plurality of glass optical fibers 110, which are the plurality of PMFs arranged perpendicular to the alignment direction of the stress applying portions with respect to the alignment plane of optical fibers, which constitute part of a fiber ribbon 400 as the plurality of bent optical fibers. The lower part of FIG. 9 (hereinafter referred to as “ribbon type (horizontally arranged PMF)” in FIG. 9) shows the end faces of the plurality of glass optical fibers 110 serving as PMFs, which are the plurality of PMFs arranged parallel to the alignment direction of the stress applying portions to the alignment plane of the transverse optical fibers, which constitute part of the fiber ribbon as the plurality of bent optical fibers.

The upper part of FIG. 9 shows the optical connection component of the present disclosure in use, including the single bent optical fiber 100. Specifically, the upper part of FIG. 9 shows the electronic substrate 700 including an optical integrated circuit chip and the like; the bent optical fiber 100 having the bent portion BA formed at one end portion thereof, the fiber holding portion 302 and the lid portion 301 attached to the one end portion where the bent portion BA is formed so that the first end surface 110a of the bent optical fiber 100 is in contact with the installation surface 700a of the electronic substrate 700, the potting resin 311 for reinforcing and protecting the bent portion BA while being supported by the fiber holding portion 302 and the lid portion 301, and the connector 321 for optically connecting the bent optical fiber 100 to an optical fiber for other premises wiring or an SMF of an external transmission line.

In the example shown in the upper part of FIG. 9, the first connecting member 300 is constituted by the fiber holding portion 302 having a V-groove 302a and the lid portion 301. The potting resin 311 supported by the first connecting member 300 is included in the reinforcing member 310. The connector 321 is included in the second connecting member 320. The bent optical fiber 100 has the glass optical fiber 110 and the resin coating 120 provided on the outer peripheral surface of the glass optical fiber 110. The glass optical fiber 110 has a first end face 110a and a second end face 110b, as well as the example shown in the upper part of FIG. 8. At the tip portion of the glass optical fiber 110 including the first end face 110a, a portion of the resin coating 120 is removed, and the bent portion BA is formed in this exposed region. The tip portion of the glass region including the second end face 110b, to which the second connecting member 320 is attached, also has a portion of the resin coating 120 removed.

By optically connecting the first end face 110a of the bent optical fiber 100 to an optical integrated circuit chip, etc. via the fiber holding portion 302 and the lid portion 301, the mechanical strength at the connection portion is improved. The bottom surface of the member comprising the fiber holding portion 302 and the lid portion 301 is inclined by about 8° to the central axis of the glass optical fiber 110 in the first connecting member 300 to avoid the increase of connection loss due to reflection at the first end face 110a of the bent optical fiber 100. In other words, in the example shown in the upper part of FIG. 9, the Z-axis indicating the height direction of the member comprising the fiber holding portion 302 and the lid portion 301 is inclined by about 8° to the installation surface 700a of the electronic substrate 700.

Although the example shown in the upper part of FIG. 9 shows the single-core type optical connection component in use, to which the single bent optical fiber 100 is applied, the fiber ribbon 400, as shown in the lower part of FIG. 8, may also be applied to the optical connection component of the present disclosure. The middle and lower parts of FIG. 9 show a part of the example that the fiber ribbon 400 shown in the lower part of FIG. 8 is applied to the optical connection component shown in the upper part of FIG. 9.

Specifically, the middle part of FIG. 9 shows the first end faces 110a of the plurality of glass optical fibers 110 constituting the fiber ribbon 400 when the member comprising the fiber holding portion 302 and the lid portion 301 is viewed along the Z-axis direction shown in the upper part of FIG. 9. These glass optical fibers 110 are installed in the V-grooves 302a of the fiber holding section 302 in the state of being rotationally aligned so that the alignment direction of the stress applying portions which apply stress to the core is perpendicular to the alignment plane of the optical fiber. On the other hand, the lower part of FIG. 9 also shows the first end surface 110a of the plurality of glass optical fibers 110 when the member comprising the fiber holding portion 302 and the lid portion 301 is viewed along the Z-axis direction. However, in the example shown in the lower part of FIG. 9, these glass optical fibers 110 are installed in the V-grooves 302a of the fiber holding section 302 in the state of being rotationally aligned so that the alignment plane of the optical fibers and the alignment direction of the stress applying portions that apply stress to the core are parallel.

FIG. 10 is a view for explaining the structure of another example of the optical connection component according to the present disclosure (hereinafter referred to as “structure 2 of optical connection component” in FIG. 10). The upper part of FIG. 10 (hereinafter referred to as “ribbon type (PMF+SMF)” in FIG. 10) shows the assembling of an optical connection component including the plurality of fiber ribbons 400. The middle part of FIG. 10 (hereinafter referred to as “before insertion of bent optical fiber” in FIG. 10) shows a plan view of the glass plate 303 as the first connection component 300. The lower part of FIG. 10 (hereinafter referred to as “after insertion of bent optical fiber” in FIG. 10) shows an example of arrangement of the bent optical fibers 100 inserted into the glass plate 303 serving as the first connecting member 300.

The top part of FIG. 10 shows an assembly configuration diagram of the optical connection component in which the plurality of fiber ribbons 400, each comprising the plurality of bent optical fibers 100, are stacked. Specifically, the upper part of FIG. 10 shows: the plurality of fiber ribbons 400, each of which is constituted by the plurality of bent optical fibers 100 and which are stacked; a glass plate 303 attached to one ends where the bent portions BA are formed to bring the first end surfaces 110a of the plurality of bent optical fibers 100 in the plurality of fiber ribbons 400 into contact with an electronic substrate, etc.; the fiber holding portion 313 and the lid portion 312 for reinforcing and protecting the bent portions BA while supported by the glass plate 303; and the array-type connector 322 for optically connecting the bent optical fibers 100 to other optical fibers for premises wiring or SMFs in external transmission lines. In each fiber ribbon 400, each of the glass optical fibers 110 of the plurality of bent optical fibers 100 is formed with the bent portion BA on the first end face 110a side.

In the example shown in the upper part of FIG. 10, the first connecting member 300 is constituted by the glass plate 303 having the plurality of through holes 303a. The reinforcing member 310 is constituted by the fiber holding portion 313 supported by the glass plate 303 and the lid portion 312. The array-type connector 322 is included in the second connecting member 320.

As shown in the middle of FIG. 10, the tip portions (including the first end faces 110a) of the glass optical fibers 110 of the plurality of bent optical fibers 100 are inserted into the plurality of through holes 303a in the glass plate 303.

In the example shown in the upper part of FIG. 10, the plurality of bent optical fibers 100 comprising each of the plurality of fiber ribbons 400 includes the glass optical fibers 110 each serving as the PMF. However, the plurality of bent optical fibers 100 applicable to the optical connection component of the present disclosure need not all be the same type of glass optical fiber. For example, the plurality of bent optical fibers 100 may be comprised of both the glass optical fibers 110, which are PMFs, and the glass optical fibers 810, which are SMFs. The lower part of FIG. 10 shows an example of a plan view of the glass plate 303 with a mixture of the glass optical fibers 110, which are PMFs, and the glass optical fibers 810, which are SMFs. In this plan view shown in the lower part of FIG. 10, the glass optical fibers 110 of PMF are inserted into the through-hole 303a located in the region RA surrounded by the dashed line, while the glass optical fibers 810 of SMF are inserted into the other through-holes 303a.

As described above, the optical connection components of the present disclosure may include two or more types of bent optical fibers with different cross-sectional structures. In this case, any combination of bent optical fibers can be selected according to the application.

### REFERENCE SIGNS LIST

100 . . . Bent optical fiber
110, 110A, 110B, 110C, 110D . . . Glass optical fiber
110a . . . First end face
110b . . . Second end face
10 . . . Core
20 . . . Cladding
20A . . . Outermost peripheral portion
30 . . . Trench layer
50A, 50B, 51A, 51B, 52A, 52B, 53 . . . Stress applying portion
120 . . . Resin coating
130 . . . Common resin
150 . . . Measurement screen
160 . . . Cross-section position
210 . . . Fiber holding portion
220 . . . Lid portion
200 . . . Glass optical fiber
300 . . . First connecting member
301, 312 . . . Lid portion
302, 313 . . . Fiber holding portion
302a . . . V-groove
303 . . . Glass plate
303a . . . Through hole
310 . . . Reinforcing member
320 . . . Second connecting member
311 . . . Potting resin
321 . . . Connector
322 . . . Array connector
400 . . . Fiber ribbon
500 . . . Cooling chamber
510 . . . Intake port
520 . . . Exhaust port
600 . . . Power supply
610, 620 . . . Discharge electrode
700 . . . Electronic substrate
700a . . . Installation surface
810 . . . Glass optical fiber
A, B, C, RA . . . Region
AX . . . Fiber axis
BA . . . Bent portion
BP . . . Bending plane
θ . . . Bending angle
θ1, θ2 . . . Twist angle
θslow . . . Absolute value of acute angle between bending plane BP and Slow-axis
L1, L2 . . . Symmetry axis
P . . . Rotation reference plane
Px, P′x . . . X-polarization mode
P′y . . . Y-polarization mode
R1, R2 . . . Boundary
S1, S1a, S2, S2a . . . Arrow
S3 . . . Arrow
S4 . . . Arrow

1. A bent optical fiber comprising:
a glass optical fiber having a first end face and a second end face and including a core extending along a central axis from the first end face toward the second end face, a stress applying portion extending along the central axis for applying stress to the core, and a cladding covering the core and the stress applying portion,
a resin coating provided on an outer peripheral surface of the glass optical fiber, wherein
an exposed region, serving as a portion of the glass optical fiber from which a portion of the resin coating has been removed and including the first end face, includes a bent portion provided at a position away from the first end face and having a curvature of 0.1 (l/mm) or more,
a stress applied to an outermost peripheral portion of the cladding is 100 MPa or less, and a stress applied to the core is 30 MPa or more.

2. The bent optical fiber according to claim 1, wherein
the exposed region includes a first non-bent region having a curvature of less than 0.1 (l/mm) and a second non-bent region having a curvature of less than 0.1 (l/mm) located on an opposite side of the first non-bent region with respect to the bent portion.

3. The bent optical fiber according to claim 2, wherein
on a first cross-section perpendicular to the central axis at a boundary between the first non-bent region and the bent portion, a first symmetry axis, which defines an arrangement pattern of the core and the stress applying portion as a line-symmetry figure, intersects a rotation reference plane containing a center of the core located inside the exposed region at a first twist angle,
on a second cross-section perpendicular to the central axis at a boundary between the second non-bent region and the bent portion, a second symmetry axis corresponding to the first symmetry axis, which defines the arrangement pattern of the core and the stress applying portion as a line-symmetry figure, intersects the rotation reference plane at a second twist angle, and
a difference between the first twist angle and the second twist angle is less than 9°.

4. The bent optical fiber according to claim 1, wherein
a polarization extinction ratio is less than −15 dB.

5. A bent optical fiber manufacturing method comprising:
preparing an optical fiber to be processed which has a first end face and a second end face and comprises: a glass optical fiber including a core extending along a central axis from the first end face toward the second end face, a stress applying portion extending along the central axis for applying stress to the core, and a cladding covering the core and the stress applying portion; and a resin coating provided on an outer peripheral surface of the glass optical fiber;
removing a portion of the resin coating for a predetermined length from the first end face to expose a portion of the glass optical fiber including the first end face;
bending a portion of an exposed region, out of the glass optical fiber from which the portion of the resin coating has been removed, by heating a section away from the first end face; and
cooling the section having been heated at a decreasing rate of 100° C./s or more until a surface temperature of the section decreases from a maximum temperature at a time of heating to 1000° C. or less.

6. A bent optical fiber manufacturing method comprising:
preparing an optical fiber to be processed which has a first end face and a second end face and comprises: a glass optical fiber including a core extending along a central axis from the first end face toward the second end face, a stress applying portion extending along the central axis for applying stress to the core, and a cladding covering the core and the stress applying portion; and a resin coating provided on an outer peripheral surface of the glass optical fiber;
removing a portion of the resin coating for a predetermined length from the first end face to expose a portion of the glass optical fiber including the first end face; and
bending a portion of an exposed region, out of the glass optical fiber from which the portion of the resin coating has been removed, by heating a section away from the first end face, wherein
in the bending, before heating the section away from the first end face, the exposed region is installed in a state in which a Slow-axis, which serves as a vibration direction in which propagation velocity is minimum on a cross-section of the glass optical fiber orthogonal to the central axis, intersects a bending plane, which includes a center of the core and defines a bending direction, at an angle θslow; and
the section is heated along the bending plane so as to form a bent portion having a curvature of 0.1 (l/mm) or more while maintaining the angle θslow.

7. The bent optical fiber manufacturing method according to claim 6, further comprising
cooling the section having been heated at a decreasing rate of 100° C./s or more until a surface temperature of the section decreases from a maximum temperature at a time of heating to 1000° C. or less.

8. A bent optical fiber produced by the bent optical fiber manufacturing method according to claim 6, wherein
the bent portion is sandwiched by a first non-bent region which includes the first end face and has a curvature of less than 0.1 (l/mm) and a second non-bent region which has a curvature of less than 0.1 (l/mm), and
in the bent portion, an angle formed by the Slow-axis with respect to the bending plane is 0° or more and 45° or less.

9. An optical connection component comprising:
the bent optical fiber according to claim 1,
a connecting member attached to a tip portion of the bent optical fiber including the first end face, and
a reinforcing member reinforcing at least the bent portion out of the bent optical fiber.

10. The optical connection component according to claim 9, comprising a plurality of the bent optical fibers, wherein
the connecting member includes a glass plate having a plurality of through holes provided respectively in correspondence with the plurality of the bent optical fibers, or a fixing member having a plurality of V-grooves provided respectively in correspondence with the plurality of the bent optical fibers.

11. The optical connection component according to claim 10, wherein
the plurality of the bent optical fibers includes at least two types of bent optical fibers having different cross-sectional structures.
